(19) United States
(12) Patent Application Publication
(10) Pub. No.: US 2021/0008563 A1
(43) Pub. Date: Jan. 14, 2021

(54) BIOLOGICAL SHEET FIXING DEVICE

(71) Applicant: BOE TECHNOLOGY GROUP CO., LTD., Beijing (CN)

(72) Inventor: Shi ZHOU, Beijing (CN)

(21) Appl. No.: 16/757,405

(22) PCT Filed: Oct. 17, 2018
(86) PCT No.: PCT/CN2018/110563

§ 371 Date: Apr. 19, 2020

(30) Foreign Application Priority Data
Feb. 13, 2018 (CN) 201810150492.0

(51) Int. Cl. B01L 9/00

(52) U.S. Cl. CPC B01L 9/52; B01L 2300/0809; B01L 2300/041; B01L 2300/0887; B01L 2300/08

(57) ABSTRACT

A biological sheet fixing device includes a carrying layer configured to carry a biological sheet, a carrying portion configured to carry the carrying layer, and a fixing portion configured to fix the carrying layer to the carrying portion.

### CROSS REFERENCE TO RELATED APPLICATIONS

The present application claims the benefit of a Chinese Patent Application No. 201810150492.0, filed on Feb. 13, 2018, the contents of which are incorporated herein by reference in their entireties.

### TECHNICAL FIELD

The present disclosure relates to the technical field of biotechnology, in particular to a biological sheet fixing device.

### BACKGROUND

Biological sheets having three-dimensional structures, including but not limited to cell membranes, physiological slices, skin samples, etc., have become research hotspots in a field of biological tissue engineering in recent years. Taking the cell membrane as an example, it has a wide range of applications in treatment of skin, cornea, heart, periodontal and other related diseases.

### SUMMARY

At least one embodiment of the present disclosure provides a biological sheet fixing device, the biological sheet fixing device comprising:

a carrying layer configured to carry the biological sheet;

a carrying portion configured to carry the carrying layer; and

a fixing portion configured to fix the carrying layer to the carrying portion.

Optionally, the fixing portion is a pressing structure configured to press a portion of the carrying layer that does not carry the biological sheet when the pressing structure is movably abutted against the carrying portion.

Optionally, at least a surface of the carrying layer facing the biological sheet is made of a material having tissue compatibility with the biological sheet.

Optionally, the material of the carrying layer is selected from at least one of polyethylene, polypropylene, polyethylene glycol, polystyrene, nylon, polyacetal, polycarbonate, polyvinyl alcohol, polyethyleneimine, polysulfone, polylactic acid, polymethacrylate, polyurethane, glass, ceramic and dextran.

Optionally, the carrying layer includes a body configured to carry the biological sheet and an extension extending from the body, the extension extending beyond the carrying portion.

Optionally, the shape of the extension is any one of a rectangle, a circle, an ellipse, a triangle and a trapezoid.

Optionally, the body defines at least one through hole.

Optionally, the body defines a plurality of through holes which are arranged in an array.

Optionally, the shape of the through hole is any one of a rectangle, a circle, an ellipse, a triangle, a trapezoid, a V-shape, an M-shaped and a W-shape.

Optionally, the biological sheet fixing device further comprises an elastic flap structure, and the carrying portion is foldably connected with the fixing portion through the elastic flap structure.

Optionally, the biological sheet fixing device further comprises a rotating portion, and the carrying portion is rotatably connected with the fixing portion through the rotating portion.

Optionally, the rotating portion comprises a rotating shaft and a shaft sleeve sleeved outside the rotating shaft.

Optionally, the rotating portion comprises a rotating shaft and at least two damping sheets fixed on the rotating shaft, a first shaft sleeve and a second shaft sleeve, wherein the first shaft sleeve is fixedly connected with the fixing portion, the second shaft sleeve is fixedly connected with the carrying portion, the first shaft sleeve and the second shaft sleeve abut against two sides of the at least two damping sheets, and are subjected to damping resistances generated by the at least two damping sheets when the first shaft sleeve and the second shaft sleeve rotate around the rotating shaft, wherein the generated damping resistance is greater than a gravity of the fixing portion.

Optionally, the biological sheet fixing device further comprises a locking portion, wherein the locking portion comprises a buckle and a clamping groove which cooperate with each other, the buckle is arranged at one of the fixing portion and the carrying portion, and the clamping groove is arranged at the other of the fixing portion and the carrying portion.

Optionally, the biological sheet fixing device further comprises a water permeable and air permeable cover film, and the cover film is positioned on the biological sheet.

Optionally, the pressing structure includes a first pressing piece and a second pressing piece, so that when the pressing structure is pressed against the carrying portion, the first pressing piece and the second pressing piece are respectively pressed at two sides of the carrying layer.

Optionally, the pressing structure includes a third pressing piece fixedly connected to sides of the first pressing piece and the second pressing piece away from a connecting side thereof.

### BRIEF DESCRIPTION OF THE DRAWINGS

Features, advantages, and technical and industrial significance of exemplary embodiments of the present disclosure will be described below with reference to the accompanying drawings, in which like reference numerals refer to like elements, and in which:

FIG. 1 is a schematic structural view of a biological sheet fixing device according to some embodiments of the present disclosure;

FIG. 2 is a schematic structural view of a biological sheet fixing device according to other embodiments of the present disclosure;

FIG. 3 is a schematic view of the biological sheet fixing device shown in FIG. 2 in a first direction;

FIG. 4 is a schematic view of the biological sheet fixing device shown in FIG. 2 in a second direction;

FIG. 5 is a schematic structural view of a carrying layer and a biological sheet of a biological sheet fixing device according to some embodiments of the present disclosure;

FIG. 6 is a schematic structural view of a biological sheet fixing device according to still further embodiments of the present disclosure;

FIG. 7 is a schematic view of the biological sheet fixing device shown in FIG. 6 in a first direction;

FIG. 8 is a schematic structural view of a carrying layer of a biological sheet fixing device according to some embodiments of the present disclosure, wherein the carrying layer has through holes;

FIG. 9 is a schematic structural view of a biological sheet and a carrying layer of a biological sheet fixing device according to some embodiments of the present disclosure, wherein the carrying layer has through holes.

### DETAILED DESCRIPTION OF THE DISCLOSURE

The embodiments of the present disclosure will be described in further detail below with reference to the drawings and specific embodiments, but not as a limitation of the present disclosure. The following description is intended to enable those skilled in the art to understand and implement the present disclosure. The following description of specific embodiments or applications is provided by way of example only. Various modifications to various embodiments will be readily apparent to those skilled in the art, and the main principles defined herein may be applied to other embodiments and applications without departing from the spirit and scope of the present disclosure. Therefore, the present disclosure is not intended to be limited to the illustrated embodiments, but is within the possible scope defined by the claims consistent with the principles and features disclosed therein. Although various embodiments are described separately, features and elements in different embodiments may be combined with each other, and the combination mode is not limited to each independent embodiment.

The terms “first,” “second,” and similar terms used in the present disclosure do not denote any order, quantity, or importance, but are used to distinguish different parts. The terms “including” or “comprising” and the like mean that the elements preceding the word include the elements listed after the word, and do not exclude the possibility of the other elements. “Upper”, “lower”, “left”, “right”, etc. are only used to indicate the relative positional relationship, and when the absolute position of the object to be described is changed, the relative positional relationship may also change accordingly. The expression “A and/or B” used in the present disclosure includes any one of A instead of B, B instead of A, and A and B, and the expression “A, B and/or C” used herein includes any one or any combination of A, B and C.

In the present disclosure, when it is described that a particular device is located between a first device and a second device, there may be intervening devices between the particular device and the first device or the second device, or there may be no intervening devices. When it is described that a particular device is connected to other device, that particular device can be directly connected to the other device without intervening devices, or can be indirectly connected to the other device with intervening devices.

All terms (including technical or scientific terms) used in the present disclosure have the same meaning as understood by one of ordinary skill in the art to which this disclosure belongs, unless specifically defined otherwise. It should also be understood that terms defined in, for example, a general dictionary should be interpreted as having a meaning consistent with their meaning in the context of the related art, without adopting idealized or extremely formal meanings, unless explicitly defined otherwise herein.

Techniques, methods and apparatus known to those of ordinary skill in the relevant art may not be discussed in detail, but the techniques, methods and apparatus should be considered as part of the specification, where appropriate.

A biological sheet fixing device disclosed by the invention is suitable for storing or transporting a biological sheet, prevents wrinkling or tearing of the biological sheet, and maintains the integrity and biological activity of the biological sheet.

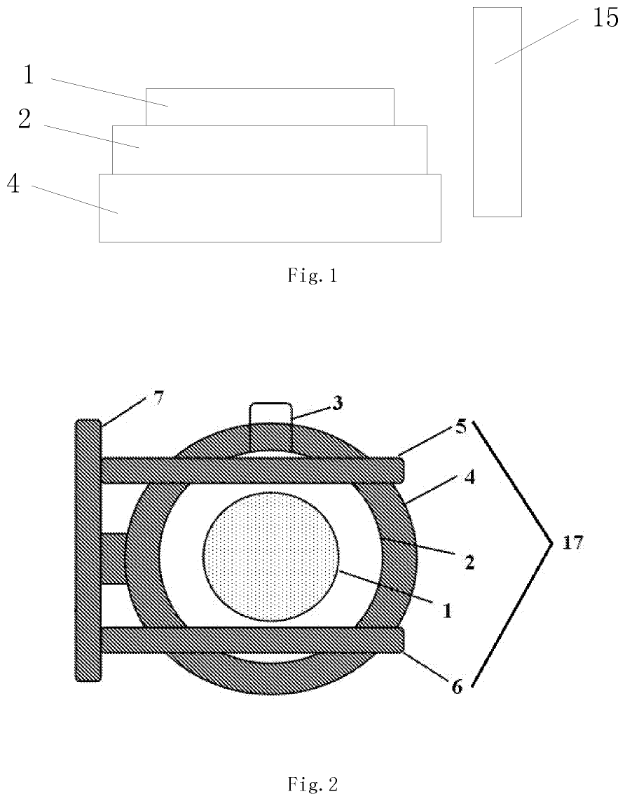

FIG. 1 is a schematic structural view of a biological sheet fixing device according to some embodiments of the present disclosure. As shown in FIG. 1, the biological sheet fixing device includes a carrying layer 2 configured to carry a biological sheet 1, a carrying portion 4 configured to carry the carrying layer 2, and a fixing portion 15 configured to fix the carrying layer 2 to the carrying portion 4.

For example, the carrying layer 2 may be of a structure and/or material suitable for attaching and flattening the biological sheet 1. Optionally, but not by way of limitation, the carrying layer 2 may adopt a carrying film, which has good flexibility and tissue compatibility, so as to prevent the biological sheet 1 carried thereon from falling off, wrinkling and/or tearing.

According to the biological sheet fixing device provided by the embodiment of the disclosure, by fixing the carrying layer 2 on the carrying portion 4 and carrying the biological sheet 1 on the carrying layer 2, the biological sheet 1 is carried on the carrying portion 4 in order to be stored and/or transported together, so that the storage and/or transportation of the biological sheet 1 is facilitated, and wrinkling or tearing of the biological sheet 1 during storage or transportation can be effectively avoided.

In some embodiments of the present disclosure, the fixation of the carrying layer 2 relative to the carrying portion 4 may be detachable.

For example, the fixing portion 15 may be configured as one or more clamping mechanisms, and at least two clips of the clamping mechanism are configured to respectively abut against the carrying layer 2 and the carrying portion 4, for example, abut against an edge of the carrying layer 2 and an edge of the carrying portion 4 or other selected positions (for example, the selected positions corresponding to an outer peripheral edge area of the carrying layer 2), thereby fixing the carrying layer 2 and the carrying portion 4 together. The clamping mechanism can be released in order to replace the carrying layer 2 or the carrying portion 4.

For example, the fixing portion 15 may be configured as one or more magnetic elements with opposite polarities located on opposite surfaces of the carrying layer 2 and the carrying portion 4, respectively, thereby fixing the carrying layer 2 and the carrying portion 4 together by magnetic attraction. An external force higher than the corresponding magnetic attraction force can be applied to replace the carrying layer 2 or the carrying portion 4.

In some embodiments of the present disclosure, the fixing portion 15 may also be configured to include at least one pressing structure 17 which is configured to be movably connected to the carrying portion 4 and pressed against the carrying portion 4, pressing a portion of the carrying layer 2 that does not carry the biological sheet 1. By avoiding pressing against a portion of the carrying layer 2 carrying the biological sheet 1, possible contamination and damage to the carried biological sheet 1 can be avoided.

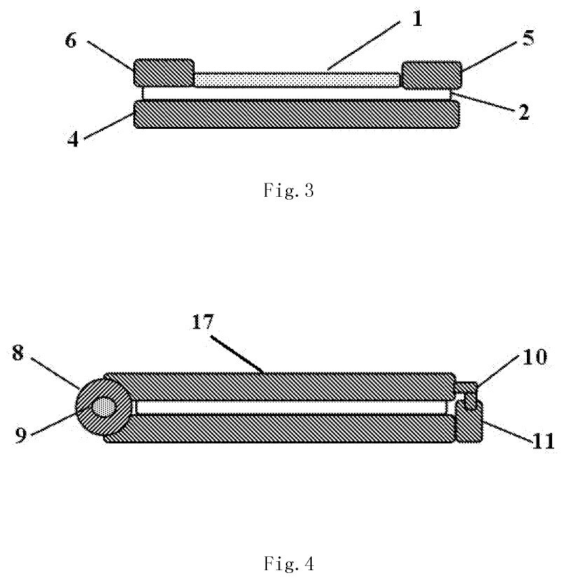

For example, as shown in FIGS. 2 and 3, the pressing structure 17 is movably abutted against the carrying portion 4, and the pressing structure 17 is configured to press the portion of the carrying layer 2 that does not carry the biological sheet 1 when the pressing structure 17 is pressed against the carrying portion 4.

In some embodiments of the present disclosure, as shown in FIG. 2, the pressing structure 17 includes a first pressing piece 5 and a second pressing piece 6. When the pressing structure 17 is pressed against the carrying portion 4, the first pressing piece 5 and the second pressing piece 6 are respectively pressed against the carrying layer 2. By arranging two separate pressing pieces, the pressing structure 17 can be more stably pressed on the carrying layer 2 to prevent the carrying layer 2 from shaking.

In some embodiments of the present disclosure, the first pressing piece 5 and the second pressing piece 6 are located at two sides of the carrying layer 2 carrying the biological sheet 1, respectively. The first pressing piece 5 and the second pressing piece 6 are respectively pressed at two sides of the carrying layer 2, so that the pressing is uniform and the pressing effect is good.

Those skilled in the art will readily understand that although the pressing structure 17 composed of the first pressing piece 5 and the second pressing piece 6 is shown in FIG. 2, the pressing structure 17 is not limited to such structure. For example, the pressing structure 17 may include different number of pressing pieces. It may also be composed of a single pressing piece having an opening whose shape corresponding to the shape of the biological sheet 1.

In some embodiments, a water permeable and air permeable cover film 14 may be disposed on the opening, and the cover film 14 may be fixed to the outer peripheral edge of the opening. The cover film 14 is provided to cover the biological sheet 1, so that the flat state of the biological sheet 1 can be maintained, the biological sheet 1 can be further fixed, and the biological sheet 1 can exchange air or nutrients through the cover film 14 to maintain the biological activity of the biological sheet 1.

In some embodiments, the cover film 14 may be pre-fixed on the peripheral edge of the opening of the pressing structure 17, so that when the pressing structure 17 is pressed against the carrying portion 4, the cover film 14 can exactly cover the biological sheet 1 without a dedicated step of arranging the cover film 14.

Wherein, the fixing portion 15 is movably (“movably” is intended to cover various moving modes, such as sliding, rotating, rolling, folding, etc.) connected to the carrying portion 4. For example, when the pressing structure 17 slides to a first position relative to the carrying portion 4, the pressing structure 17 does not press against the carrying portion 4, and when the pressing structure 17 slides to a second position relative to the carrying portion 4, the pressing structure 17 presses against the carrying portion 4. Of course, the pressing structure 17 can also be movably connected to the carrying portion 4 by other means, so as to realize that the pressing structure 17 can press against the carrying portion 4 to press the portion of the carrying layer 2 that does not carry the biological sheet 1, and realize that the pressing structure 17 can be moved away from the carrying portion 4 to place the carrying layer 2 on the carrying portion 4 or take the carrying layer 2 away from the carrying portion 4.

In some embodiments, the pressing structure 17 may also be rotatably connected to the carrying portion 4. Referring to FIG. 2, the biological sheet fixing device may further include a rotating portion 7, and the carrying portion 4 is rotatably connected with the pressing structure 17 through the rotating portion 7. The carrying portion 4 is rotatably connected with the pressing structure 17 through the rotating portion 7. When the rotating portion 7 rotates to a first position, the pressing structure 17 can press against the carrying portion 4 to press the portion of the carrying layer 2 that does not carry the biological sheet 1. When the rotating portion 7 rotates to a second position, the pressing structure 17 moves away from the carrying portion 4 to place the carrying layer 2 on the carrying portion 4 or take the carrying layer 2 away from the carrying portion 4.

In some embodiments, the rotating portion 7 can also be an elastic flap structure, and the carrying portion 4 is foldably connected with the pressing structure 17 through the elastic flap structure, so that the pressing structure 17 can be folded to a pressing position relative to the carrying portion 4, and when the pressing structure 17 moves away from the carrying portion 4 to a position, the elastic flap structure can overcome the gravity of the pressing structure 17 to keep the pressing structure 17 at the position relative to the carrying portion 4, so that the carrying layer 2 and the biological sheet 1 carried on the carrying layer 2 can be conveniently taken and placed.

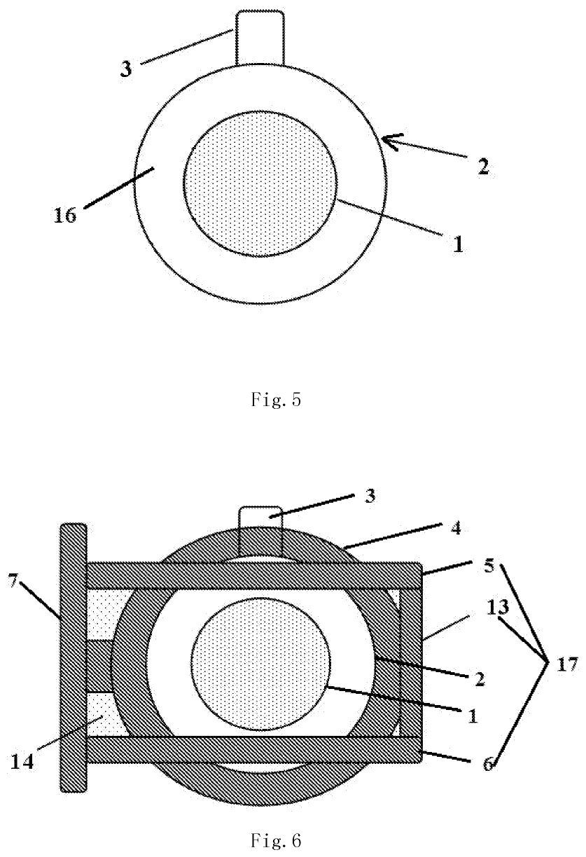

In some embodiments, referring to FIG. 4, the rotating portion 7 includes a rotating shaft 9 and a shaft sleeve 8 sleeved outside the rotating shaft 9. The rotating shaft 9 is fixedly connected with the carrying portion 4, the shaft sleeve 8 is fixedly connected with the pressing structure 17, and the relative rotation of the rotating shaft 9 and the shaft sleeve 8 causes the carrying portion 4 and the pressing structure 17 to relatively rotate so that the pressing structure 17 can be pressed against or move away from the carrying portion 4.

In some embodiments, the rotating shaft 9 is fixedly connected with the pressing structure 17, while the shaft sleeve 8 is fixedly connected with the carrying portion 4, so that the carrying portion 4 and the pressing structure 17 can rotate relative to each other.

In some embodiments, the rotating portion 7 comprises a rotating shaft and at least two damping sheets fixed on the rotating shaft, a first shaft sleeve and a second shaft sleeve, wherein the first shaft sleeve is fixedly connected with the pressing structure 17, the second shaft sleeve is fixedly connected with the carrying portion 4, the first shaft sleeve and the second shaft sleeve are abutted at two sides of at least two damping sheets, and are subjected to damping resistance generated by at least two damping sheets when the first shaft sleeve and the second shaft sleeve rotate around the rotating shaft, wherein the generated damping resistance is larger than a gravity of the pressing structure 17. When the rotating portion 7 rotates to a certain angle, the pressing structure 17 moves away from the carrying portion 4, and the damping generated between at least two damping sheets can prevent the pressing structure 17 from automatically falling by gravity so as to keep at the certain angle, thus facilitating the taking and placing of the carrying layer 2 and the biological sheet 1 carried on the carrying layer 2.

In some embodiments of the present disclosure, the biological sheet 1 may be a cell sheet (cell membrane) having a three-dimensional structure, a tissue engineering cytoskeleton, or a single-layered plant tissue leaf, an epidermal tissue, a cell culture, or the like.

By carrying the biological sheet 1 on the carrying layer 2, the biological sheet 1 is carried by the carrying portion 4, and the pressing structure 17 is movably connected to the carrying portion 4. The pressing structure 17 presses the portion of the carrying layer 2 that does not carry the biological sheet 1 by pressing against the carrying portion 4 to prevent the biological sheet 1 from wrinkling or tearing during storage or transportation. The pressing structure 17 can also be conveniently at least partially detached from the carrying portion 4, thereby facilitating the taking out of the biological sheet 1.

In some embodiments of the present disclosure, at least a surface of the carrying layer 2 facing the biological sheet 1 is made of a material having tissue compatibility, which refers to the tissue compatibility with the structure constituting the biological sheet. When the biological sheet 1 is carried on the carrying layer 2, the biological sheet 1 is attached to a tissue compatible surface of the carrying layer 2 to avoid movement between the biological sheet 1 and the carrying layer 2. Furthermore, when the carrying layer 2 carries the biological sheet 1, the biological sheet 1 and the biological sheet fixing device can be prevented from colliding with each other to be damaged during transportation. The pressing structure 17 does not need to contact the biological sheet 1, thereby avoiding damage to the biological sheet 1 caused by contact. Pressing the portion of the carrying layer 2 that does not carry the biological sheet 1 can ensure that the carrying layer 2 does not move with the biological sheet fixing device.

For example, the material of the carrying layer 2 is selected from at least one of polyethylene, polypropylene, polyethylene glycol, polystyrene, nylon, polyacetal, polycarbonate, polyvinyl alcohol, polyethyleneimine, polysulfone, polylactic acid, polymethacrylate, polyurethane, glass, ceramic, and dextran.

Referring to FIG. 5, in some embodiments, the carrying layer 2 includes a body 16 configured to carry the biological sheet 1 (i.e., a projection of the biological sheet 1 perpendicular to a plane in which the carrying layer 2 is located is in the body 16) and an extension 3 extending from the body 16. When the carrying layer 2 is in place, the extension 3 extends beyond the carrying portion 4 (i.e., at least a portion of the extension 3 extends beyond a partial edge of the carrying portion 4), as shown in FIGS. 2 and 6. Therefore, when the pressing structure 17 is not pressed against the carrying portion 4, the carrying layer 2 can be conveniently clamped to place the carrying layer 2 on the carrying portion 4 or take the carrying layer 2 away from the carrying portion 4.

For example, the shape of the extension 3 may be a regular shape, for example, any one of a rectangle (for example a rounded rectangle as shown in FIGS. 2, 4 and 6), a circle, an ellipse, a triangle and a trapezoid, so as to facilitate machining and manufacturing.

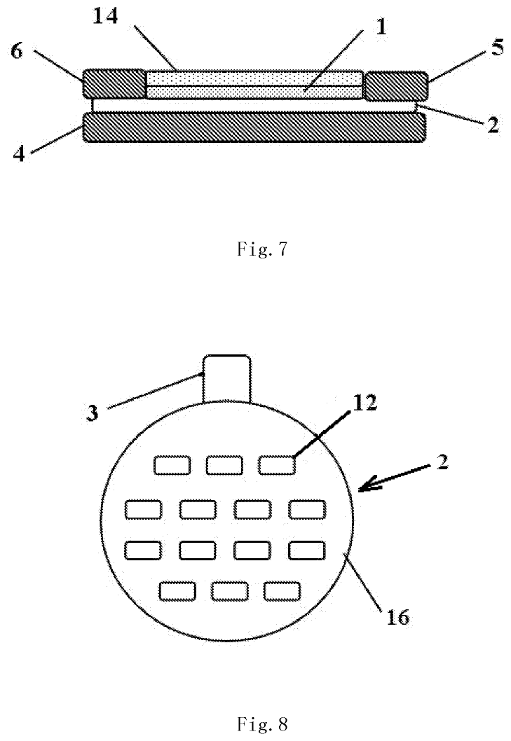

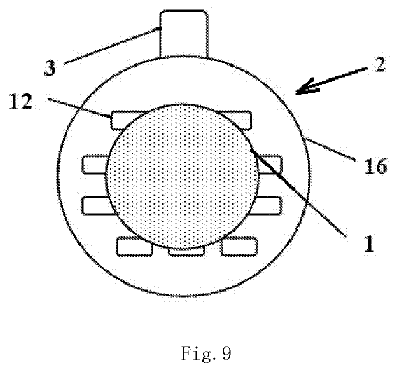

In some embodiments of the present disclosure, the body 16 defines at least one through hole 12 in order to enable the biological sheet 1 to fully contact with air or protective liquid or culture solution. Referring to FIGS. 8 and 9, the body 16 defines a plurality of through holes 12. Under normal circumstances, a protective liquid device or a culture solution device is provided at a lower portion of the biological sheet fixing device. When the biological sheet 1 is carried on the carrying layer 2 and the carrying layer 2 is fixed on the biological sheet fixing device together with the biological sheet 1, the biological sheet 1 can be fully contacted with air or the protective liquid or the culture solution through the plurality of through holes 12 to maintain the biological activity of the biological sheet 1. In addition, when the carrying layer 2 defines a plurality of through holes 12, vacuum can be prevented from being formed between the biological sheet and the carrying layer 2, so that the biological sheet 1 can be conveniently taken from the carrying layer 2 and placed on the carrying layer 2.

In some embodiments, referring to FIGS. 8 and 9, the plurality of through holes 12 are arranged in an array in order to make the contact of the biological sheet 1 with air or protective liquid or culture solution more sufficient and uniform.

In the biological sheet fixing device of the embodiment of the present disclosure, the shape of the through hole 12 of the carrying layer 2 is any one of a rectangle (a rounded rectangle as shown in FIGS. 8 and 9), a circle, an ellipse, a triangle, a trapezoid, a V-shape, an M-shaped, and a W-shape. The through hole 12 has a regular shape, which is easy to machine and manufacture, and enables the biological sheet 1 to be sufficiently contacted with air or protective liquid or culture solution.

In some embodiments, the biological sheet fixing device further includes a locking portion configured to lock the fixing portion 15 and the carrying portion 4 in place when the biological sheet 1 is disposed on the carrying layer 2 and the fixing portion 15 moves to a pressing position with respect to the carrying portion 4, thereby avoiding displacement of various components, preventing loosening of the biological sheet fixing device, and avoiding detachment of the biological sheet 1 caused thereby.

The locking portion can be implemented in various ways. As an example, referring to FIG. 4, the locking portion includes a buckle 10 and a clamping groove 11 that cooperate with each other, the buckle 10 is provided on either one of the pressing structure 17 and the carrying portion 4, and the clamping groove 11 is provided on the other one of the pressing structure 17 and the carrying portion 4. The pressing structure 17 and the carrying portion 4 are locked through the cooperation of the buckle 10 and the clamping groove 11, so that the pressing structure 17 is pressed against the carrying portion 4, and the carrying layer 2 is prevented from moving away from the biological sheet fixing device during transportation, or when the buckle 10 and the clamping groove 11 are in a detached state, the carrying layer 2 and the biological sheet 1 carried on the carrying layer 2 can be taken and placed.

Referring to FIGS. 6 and 7, in some embodiments, the biological sheet fixing device may further include a water-permeable and air-permeable cover film 14 disposed on the biological sheet 1. The provision of the cover film 14 can maintain the flat state of the biological sheet 1, further fix the biological sheet 1, and also enable the biological sheet 1 to exchange air or nutrients through the cover film 14 to maintain the biological activity of the biological sheet 1.

In some embodiments, the cover film 14 may be made of a high molecular polymer material having a microporous structure, for example, a material of the carrying layer 2.

Referring to FIGS. 6 and 7, in some embodiments, in order to make the force of the first pressing piece 5 and the second pressing piece 6 pressing a portion of the carrying layer 2 to be loaded with the biological sheet 1 more uniform, the pressing structure 17 further includes a third pressing piece 13 fixedly connected to sides of the first pressing piece 5 and the second pressing piece 6 away from a connecting side thereof. Other implementations of the pressing structure 17 have been given above. The first pressing piece 5, the second pressing piece 6, the third pressing piece 13 and the rotating portion 7 shown in FIG. 6 form a closed frame. Therefore, it makes the fixing of the covering film 14 more convenient, and compared with the structure of the single pressing piece described above, it saves materials and makes the manufacture simpler.

Referring to FIGS. 6 and 7, the pressing structure 17 presses the cover film 14 by pressing against the carrying portion 4. The carrying layer 2 carries the biological sheet 1, the cover film 14 covers the biological sheet 1, and the pressing structure 17 presses the cover film 14 and the carrying layer 2. The biological sheet 1 exchanges air or nutrients through the cover film 14 and the carrying layer 2, and the cover film 14 and the carrying layer 2 can also prevent the biological sheet 1 from moving during storage or transportation, thereby preventing the biological sheet 1 from wrinkling or tearing during storage or transportation.

It should be noted that the present disclosure uses expressions “an embodiment”, “one embodiment” or “some embodiments” along with their derivatives, and these expressions and terms mean that a specific feature, structure or characteristic described in connection with the embodiment is included in at least one embodiment. The appearances of the phrase “in one embodiment” in various places in this disclosure are not necessarily all referring to the same embodiment.

Although the subject matter has been described in language specific to structural features and/or methodological acts, it should be understood that the subject matter defined in the appended claims is not necessarily limited to the specific features or acts described above. On the contrary, the specific features and acts described above are disclosed as exemplary forms of implementing the claims. Obviously, those skilled in the art can make various changes and modifications to the embodiments of the present disclosure without departing from the spirit and scope of the present disclosure. Thus, if these modifications and variations of the present disclosure fall within the scope of the claims of the present disclosure and their equivalents, the present disclosure is also intended to include these modifications and variations.

1. A biological sheet fixing device comprising:
a carrying layer configured to support a biological sheet;
a carrying portion configured to support the carrying layer; and
a fixing portion configured to fix the carrying layer to the carrying portion.

2. The biological sheet fixing device according to claim 1, wherein the fixing portion comprises a pressing structure configured to press a portion of the carrying layer that does not overlap the biological sheet when the pressing structure is movably abutted against the carrying portion.

3. The biological sheet fixing device according to claim 1, wherein at least a surface of the carrying layer facing the biological sheet comprises a material having tissue compatibility with the biological sheet.

4. The biological sheet fixing device according to claim 3, wherein a material of the carrying layer is selected from at least one of polyethylene, polypropylene, polyethylene glycol, polystyrene, nylon, polyacetal, polycarbonate, polyvinyl alcohol, polyethyleneimine, polysulfone, polylactic acid, polymethacrylate, polyurethane, glass, ceramic, or dextran.

5. The biological sheet fixing device according to claim 1,
wherein the carrying layer comprises a body configured to support the biological sheet and an extension that extends from the body,
wherein the extension extends beyond the carrying portion.

6. The biological sheet fixing device according to claim 5, wherein a shape of the extension comprises a rectangle, a circle, an ellipse, a triangle or a trapezoid.

7. The biological sheet fixing device according to claim 5, wherein the body defines at least one through hole.

8. The biological sheet fixing device according to claim 7,
wherein the body defines a plurality of through holes, and
wherein the plurality of through holes are arranged in an array.

9. The biological sheet fixing device according to claim 7, wherein a shape of the through hole comprises a rectangle, a circle, an ellipse, a triangle, a trapezoid, a V-shape, an M-shape, or a W-shape.

10. The biological sheet fixing device according to claim 1,
wherein the biological sheet fixing device further comprises an elastic flap structure, and
wherein the carrying portion is foldably connected with the fixing portion through the elastic flap structure.

11. The biological sheet fixing device according to claim 1,
wherein the biological sheet fixing device further comprises a rotating portion, and
wherein the carrying portion is rotatably connected with the fixing portion through the rotating portion.

12. The biological sheet fixing device according to claim 11, wherein the rotating portion comprises a rotating shaft and a shaft sleeve sleeved outside the rotating shaft.

13. The biological sheet fixing device according to claim 11,
wherein the rotating portion comprises a rotating shaft and at least two damping sheets fixed on the rotating shaft, a first shaft sleeve and a second shaft sleeve,
wherein the first shaft sleeve is fixedly connected with the fixing portion,
wherein the second shaft sleeve is fixedly connected with the carrying portion,
wherein the first shaft sleeve and the second shaft sleeve respectively abut against outer sides of the at least two damping sheets, and are subjected to damping resistance generated by the at least two damping sheets when the first shaft sleeve and the second shaft sleeve rotate around the rotating shaft, and
wherein the damping resistance that was generated is larger than a gravity of a pressing structure.

14. The biological sheet fixing device according to claim 1,
wherein the biological sheet fixing device further comprises a locking portion,
wherein the locking portion comprises a buckle and a clamping groove which cooperate with each other,
wherein the buckle is on one of the fixing portion and the carrying portion, and
wherein the clamping groove is on a different one of the fixing portion and the carrying portion.

15. The biological sheet fixing device according to claim 1,
wherein the biological sheet fixing device further comprises a water permeable and air permeable cover film, and
wherein the cover film is on the biological sheet.

16. The biological sheet fixing device according to claim 2,
wherein the pressing structure comprises a first pressing piece and a second pressing piece, so that when the pressing structure is pressed against the carrying portion, the first pressing piece and the second pressing piece are respectively pressed at two sides of the carrying layer.

17. The biological sheet fixing device according to claim 16, wherein the pressing structure comprises a third pressing piece fixedly connected to sides of the first pressing piece and the second pressing piece away from a connecting side thereof.

18. The biological sheet fixing device according to claim 11,
wherein the biological sheet fixing device further comprises a locking portion,
wherein the locking portion comprises a buckle and a clamping groove which cooperate with each other,
wherein the buckle is on one of the fixing portion and the carrying portion, and
wherein the clamping groove is on a different one of the fixing portion and the carrying portion.
